(19) United States
(12) Patent Application Publication
(10) Pub. No.: US 2025/0000147 A1
(43) Pub. Date: Jan. 2, 2025

(54) VAPORIZER AND AEROSOL GENERATING DEVICE INCLUDING THE SAME

(71) Applicant: KT&G CORPORATION, Daejeon (KR)

(72) Inventors: Won Kyeong LEE, Gyeonggi-do (KR); Min Kyu KIM, Seoul (KR); Paul Joon SUNWOO, Seoul (KR)

(73) Assignee: KT&G CORPORATION, Daejeon (KR)

(21) Appl. No.: 18/579,672

(22) PCT Filed: Oct. 12, 2023
(86) PCT No.: PCT/KR2023/015725

§ 371 Date: Jan. 16, 2024

(30) Foreign Application Priority Data
Oct. 21, 2022 (KR) 10-2022-0136835

(51) Int. Cl. A24F 40/44; A24F 40/10; A24F 40/465; A24F 40/51; A24F 40/57; H05B 3/26

(52) U.S. Cl. CPC A24F 40/44; A24F 40/10; A24F 40/465; A24F 40/51; A24F 40/57; H05B 3/265; H05B 2203/013; H05B 2203/021

(57) ABSTRACT

A vaporizer includes a storage unit configured to store an aerosol generating material, a first wick configured to absorb the aerosol generating material from the storage unit, a heating pattern printed on at least one surface of the first wick and configured to heat the aerosol generating material absorbed into the first wick, and a sensing pattern printed on the same surface of the first wick as the heating pattern and configured to measure a temperature of the heating pattern.

### TECHNICAL FIELD

Embodiments relate to a vaporizer and an aerosol generating device including the same, and more particularly, to a vaporizer having improved atomization performance and an aerosol generating device including the same.

### BACKGROUND ART

Recently, the demand for a technology for replacing a method of supplying aerosols by burning a cigarette as in the related art has increased. For example, studies have been conducted on a method of supplying aerosols having flavors by generating aerosols from an aerosol generating material in a liquid state or a solid state or generating a vapor from an aerosol generating material in a liquid state and then passing the vapor through a fragrance medium in a solid state.

Recently, an aerosol generating article capable of generating aerosols by heating an aerosol generating article has been proposed as an alternative to a method of supplying aerosols by burning a cigarette. For example, an aerosol generating device may refer to a device capable of generating aerosols by heating an aerosol generating material in a liquid state or a solid state to a certain temperature through a heater.

When using aerosol generating devices, smoking may be enabled without additional products such as lighters, and smoking convenience of users may be improved, such as enabling the users to smoke as much as desired. Therefore, recently research on aerosol generating devices has gradually increased.

Aerosol generating devices for generating aerosols by generating heat include heaters for generating heat and sensors for detecting temperatures due to the heat of the heaters. Arrangement structures of the heaters and the sensors need to be improved to increase amounts of aerosol generated in the aerosol generating devices and improve precise control performance of the heaters.

### DISCLOSURE OF INVENTION

### Technical Problem

Embodiments provide a vaporizer having improved atomization performance by increasing an area in which a wick and a heating element contact each other, and an aerosol generating device including the same.

Embodiments provide a vaporizer capable of precisely detecting a change in a temperature due to beat of a heating element and an aerosol generating device including the same.

Embodiments provide a vaporizer having a dual atomization function and an aerosol generating device including the same.

The technical problems to be solved by the embodiments of the disclosure are not limited to the above-described problems, and problems that are not mentioned will be clearly understood by those of ordinary skill in the art from the disclosure and the accompanying drawings.

### Solution to Problem

According to an aspect of the disclosure, a vaporizer includes a storage unit configured to store an aerosol generating material, a first wick configured to absorb the aerosol generating material from the storage unit, a heating pattern printed on at least one surface of the first wick and configured to heat the aerosol generating material absorbed into the first wick, and a sensing pattern printed on the same surface of the first wick as the heating pattern and configured to measure a temperature of the heating pattern.

According to another aspect of the disclosure, an aerosol generating device includes a vaporizer, a battery configured to supply power to the vaporizer, and a controller configured to control the power supplied to the battery and the vaporizer.

### Advantageous Effects of Invention

According to a vaporizer and an aerosol generating device including the same, according to embodiments, a temperature of a heating pattern, which is a heating element, may be measured without arranging a separate temperature sensor.

In addition, according to the vaporizer and the aerosol generating device including the same, according to the embodiments, atomization performance may be improved by increasing a contact area between an aerosol generating material and the heating element.

Technical problems to be solved by the embodiments are not limited to the above-described problems, and problems that are not mentioned will be clearly understood by those of ordinary skill in the art from the disclosure and the accompanying drawings.

### BRIEF DESCRIPTION OF DRAWINGS

FIGS. 1 to 3 are diagrams illustrating examples of an aerosol generating device including a vaporizer, according to an embodiment.

FIG. 4 is a cross-sectional view schematically illustrating the aerosol generating device illustrated in FIG. 2.

FIG. 5 is a cross-sectional view schematically illustrating the aerosol generating device illustrated in FIG. 3.

FIG. 6 is a cross-sectional view of a vaporizer of FIG. 5 taken in a direction A-A, according to an embodiment.

FIG. 7 is an exploded perspective view of a portion of a vaporizer according to an embodiment.

FIG. 8 is a front view illustrating a portion of a vaporizer according to an embodiment.

FIG. 9A is a top view illustrating a portion of a vaporizer according to another embodiment.

FIG. 9B is a top view illustrating a portion of a vaporizer according to another embodiment.

FIGS. 10A and FIG. 10B are top views illustrating a portion of a vaporizer according to some embodiments.

FIG. 11 is a top view of a portion of a vaporizer of FIG. 9A, according to some embodiments.

FIG. 12 is a top view of a portion of a vaporizer of FIG. 11, according to some embodiments.

FIG. 13 is a front view illustrating a portion of a vaporizer according to another embodiment.

FIGS. 14A and 14B are each a perspective view illustrating a portion of a vaporizer according to an embodiment.

FIG. 15 is a front view illustrating a portion of a vaporizer in which a mesh body is arranged, according to an embodiment.

FIG. 16 is a block diagram of an aerosol generating device according to an embodiment.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the beat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. In other words, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by beat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the suspector, the suspector generates heat to heat an aerosol generating article. In addition, optionally, the suspector may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

FIGS. 1 to 3 are diagrams illustrating examples of an aerosol generating device including a vaporizer, according to an embodiment.

Referring to FIGS. 1 to 3, an aerosol generating device 1 may include a battery 11, a controller 12, a heater 13, and a vaporizer 14.

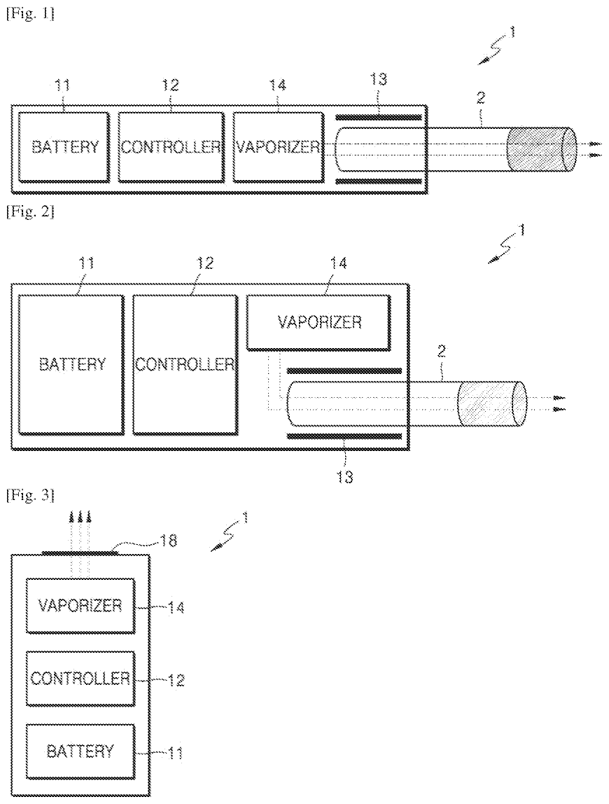

The aerosol generating device 1 of FIGS. 1 and 2 may include a housing including an accommodation space in which an aerosol generating article 2 is accommodated. The aerosol generating article 2 may be inserted into the aerosol generating device 1, and accordingly, the aerosol generating article 2 may be accommodated in the accommodation space of the housing. In addition, FIGS. 1 and 2 illustrate that the aerosol generating device 1 includes the heater 13, but the heater 13 may be omitted as needed.

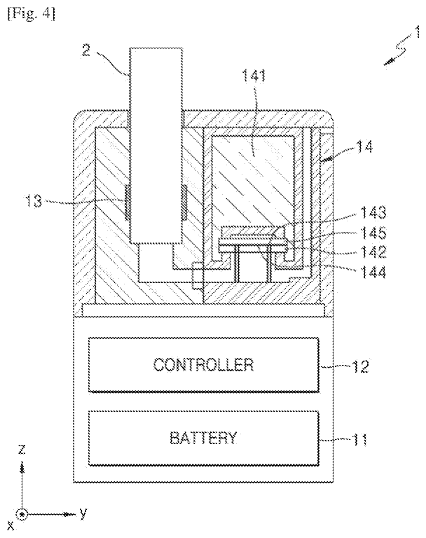

The aerosol generating device 1 of FIG. 3 may not include a space into which the aerosol generating article 2 may be inserted, and accordingly, the heater 13 for heating the aerosol generating article 2 may not be arranged.

The aerosol generating device 1 illustrated in FIGS. 1 to 3 may include only components related to the present embodiment. Accordingly, the aerosol generating device 1 may further include other components, in addition to the components illustrated in FIGS. 1 to 3.

FIG. 1 illustrates that the battery 11, the controller 12, the vaporizer 14, and the heater 13 are arranged in a row. In addition, as illustrated in FIG. 2, the vaporizer 14 and the heater 13 may be arranged in parallel. However, the internal structure of the aerosol generating device 1 is not limited to those illustrated in FIGS. 1 to 3. In other words, the arrangement of the battery 11, the controller 12, the vaporizer 14, and the heater 13 may be changed according to the design of the aerosol generating device 1.

The battery 11 may supply power used to operate the aerosol generating device 1. For example, the battery 11 may supply power so that the heater 13 or the vaporizer 14 may be heated, and may supply power needed for the controller 12 to operate. In addition, the battery 11 may supply power needed for a display, a sensor, a motor, and the like installed in the aerosol generating device 1 to operate.

The controller 12 may control overall operation of the aerosol generating device 1. In detail, the controller 12 may control operations of the battery 11, the heater 13, and the vaporizer 14, as well as operations of the other components included in the aerosol generating device 1. In addition, the controller 12 may determine whether or not the aerosol generating device 1 is in an operable state, by identifying a state of each of the components of the aerosol generating device 1.

The controller 12 may include at least one processor. The processor may be implemented as an array of a plurality of logical gates, or a combination of a general-purpose microprocessor and a memory that stores programs that may be executed by the microprocessor. In addition, it may be understood by one of ordinary skill in the art to which the present embodiment belongs that the processor may be implemented as other types of hardware.

The heater 13 may be heated by power supplied from the battery 11. For example, when the aerosol generating article 2 is inserted into the aerosol generating device 1, the heater 13 may be located outside the aerosol generating article 2. Accordingly, the heated heater 13 may increase a temperature of an aerosol generating material within the aerosol generating article 2.

The heater 13 may be an electrically resistive heater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be pre-set in the aerosol generating device 1 or may be set by a user.

As another example, the heater 13 may include an induction heater. In detail, the heater 13 may include an electrically conductive coil for heating an aerosol generating article in an induction heating method, and the aerosol generating article may include a susceptor which may be heated by the induction heater.

FIGS. 1 and 2 illustrate that the heater 13 is arranged outside the aerosol generating article 2, but the heater 13 is not limited thereto. For example, the heater 13 may include a tube-type heating element, a plate-type heating element, a needle-type heating element, or a rod-type heating element, and may heat the inside or the outside of the aerosol generating article 2, according to the shape of the heating element.

Also, the aerosol generating device 1 may include a plurality of heaters 130. Here, the plurality of heaters 130 may be inserted into the aerosol generating article 2 or may be arranged outside the aerosol generating article 2. Also, some of the plurality of heaters 130 may be inserted into the aerosol generating article 2 and the others may be arranged outside the aerosol generating article 2. In addition, the shape of the heater 13 is not limited to the shapes illustrated in FIGS. 1 through 3 and may include various shapes.

The vaporizer 14 may be a component that stores an aerosol generating material, and generates a vaporized aerosol by heating the aerosol generating material.

The vaporizer 14 may include a liquid storage, a liquid delivery element, and a heating element, but is not limited thereto. For example, the liquid storage, the liquid delivery element, and the heating element may be included in the aerosol generating device 1 as independent modules.

The liquid storage may store the aerosol generating material. For example, the aerosol generating material may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the aerosol generating material may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the aerosol generating material may include an aerosol forming substance, such as glycerin and propylene glycol.

The liquid delivery element may deliver the aerosol generating material in the liquid storage to the heating element. For example, the liquid delivery element may be a wick such as cotton fiber, ceramic fiber, glass fiber, or porous ceramic, but is not limited thereto.

The heating element may be an element for heating the aerosol generating material delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may heat the aerosol generating material by transferring heat to the aerosol generating material in contact with the heating element. As a result, an aerosol may be generated from the aerosol generating material.

The generated aerosol may move along an air flow passage. As illustrated in FIGS. 1 and 2, the aerosol moved along the air flow passage may be delivered to the user by passing through the aerosol generating article 2. As illustrated in FIG. 3, the aerosol moved along the air flow passage may be delivered to the user through a mouthpiece 18.

The vaporizer 14 may be referred to as a cartomizer or an atomizer, but is not limited thereto.

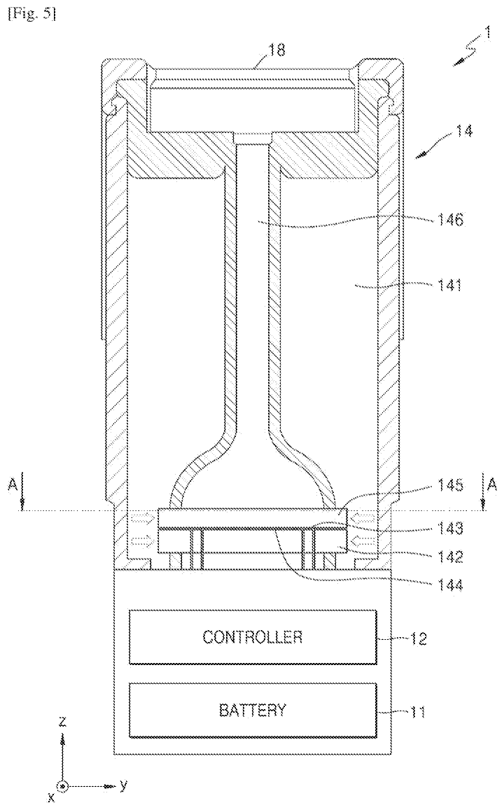

According to an embodiment, the vaporizer 14 may be a cartridge that may be inserted into and detached from the aerosol generating device 1. When the aerosol generating material stored is all consumed, the vaporizer 14 may be replenished with an aerosol generating material or may be replaced with another vaporizer 14 that stores an aerosol generating material. The structure and arrangement of the vaporizer 14 are described below with reference to FIGS. 4 to 8.

FIGS. 4 to 6 are views illustrating a vaporizer of an aerosol generating device.

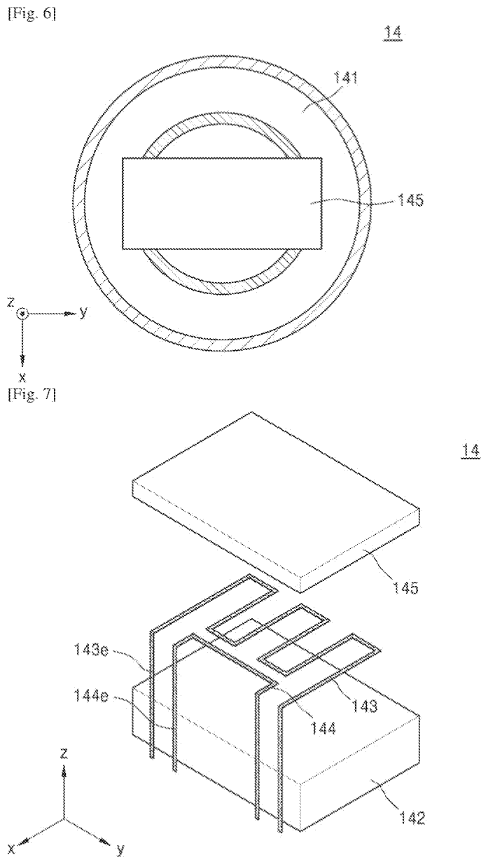

FIG. 4 is a cross-sectional view schematically illustrating the aerosol generating device illustrated in FIG. 2, and FIG. 5 is a cross-sectional view schematically illustrating the aerosol generating device illustrated in FIG. 3. FIG. 6 is a cross-sectional view of a vaporizer of FIG. 5 taken in a direction A-A, according to an embodiment.

Referring to FIGS. 4 and 5, a vaporizer 14 according to an embodiment may include a storage unit 141, a first wick 142, a heating pattern 143, a sensing pattern 144, and a second wick 145.

Here, the storage unit 141, the first and second wicks 142 and 145, and the heating pattern 143 may be respectively the same as the liquid storage, the liquid delivery element, and the heating element included in the vaporizer 14 described above with reference to FIGS. 1 to 3.

The storage unit 141 may include an empty space surrounded by an outer wall and an inner wall thereof. An aerosol generating material may be stored in the empty space of the storage unit 141.

Referring further to FIG. 6, the first wick 142 and/or the second wick 145 may be arranged inside the storage unit 141. A portion of the first wick 142 and/or the second wick 145 may be in contact with the aerosol generating material stored in the storage unit 141. Both ends of the first wick 142 and/or both ends of the second wick 145 may be in contact with the aerosol generating material.

The storage unit 141 may be sealed to prevent the aerosol generating material from leaking to the outside of the storage unit 141 through another path other than the first wick 142 and/or the second wick 145.

The storage unit 141 may be manufactured in various shapes, and according to an embodiment, the storage unit 141 may have a shape such as a cylindrical shape or a rectangular parallelepiped shape extending in one direction.

The storage unit 141 may be connected to the first wick 142 and/or the second wick 145, and the aerosol generating material in the storage unit 141 may be transported to the outside of the storage unit 141 through the first wick 142 and/or the second wick 145.

For example, the storage unit 141 may include a plurality of openings respectively connected to both ends of the first wick 142 and/or both ends of the second wick 145. The gap between the storage unit 141 and the first wick 142 and/or the second wick 145 may be sealed to prevent the aerosol generating material from leaking through a region other than the first wick 142 and/or the second wick 145.

The first wick 142 and the second wick 145 may absorb the aerosol generating material from the storage unit 141.

The heating pattern 143 may generate an aerosol by heating the aerosol generating material absorbed into the first wick 142 and the second wick 145 to vaporize the aerosol generating material.

The sensing pattern 144 may be a temperature sensor and may be arranged to measure a temperature of the heating pattern 143.

Referring to FIG. 4, the aerosol generated by the heating pattern 143 may move to an accommodation space for accommodating an aerosol generating article 2, through an air flow passage that is formed in a main body of the aerosol generating device 1 and connected to an outlet of the vaporizer 14. The aerosol may be delivered to the user by passing through the aerosol generating article 2 inserted into the accommodation space of the main body.

Referring to FIG. 5, the aerosol generated by the heating pattern 143 may move along an extension direction of an air flow passage 146 formed inside the vaporizer 14. A mouthpiece 18 may be located at one end of the air flow passage 146. The aerosol may be delivered to the user through the mouthpiece 18.

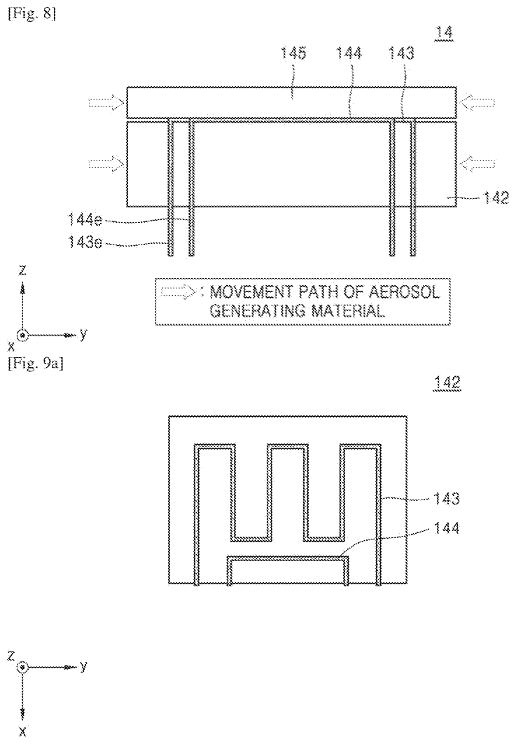

Hereinafter, the first wick 142, the heating pattern 143, the sensing pattern 144, and the second wick 145 are described below in more detail with reference to FIGS. 7 and 8.

FIGS. 7 and 8 are views illustrating a first wick 142, a heating pattern 143, a sensing pattern 144, and a second wick 145, which are included in a vaporizer 14 according to an embodiment.

FIG. 7 is an exploded perspective view of a portion of a vaporizer according to an embodiment, and FIG. 8 is a front view illustrating a portion of a vaporizer according to an embodiment.

Referring to FIGS. 7 and 8, the vaporizer 14 according to an embodiment may include the first wick 142, the heating pattern 143, the sensing pattern 144, and the second wick 145.

The first wick 142 may absorb an aerosol generating material by receiving the aerosol generating material from a storage unit (not shown) that stores the aerosol generating material.

In an embodiment, the first wick 142 may have a hexahedral shape. For example, the first wick 142 may have a rectangular pillar shape. However, the embodiments are not limited to the above-described example, and a wick may have an approximately cylindrical, elongated, rod, or needle shape.

A portion of the first wick 142 may absorb the aerosol generating material supplied from the storage unit. For example, the aerosol generating material absorbed into the portion of the first wick 142 may move to the other portion the first wick 142 according to capillary action.

The heating pattern 143 and the sensing pattern 144 may be printed on the first wick 142. Here, printing may refer to all methods of permanently attaching a pattern to the first wick 142, such as application, spraying, deposition, plating, and immersion.

The first wick 142 needs to include a material having appropriate strength and stability while operating as a wick that absorbs an aerosol generating material, to apply a print technology to the first wick 142. For example, the first wick 142 may include porous ceramic.

The heating pattern 143 may be printed on at least one surface of the first wick 142 to heat the aerosol generating material absorbed into the first wick 142.

The heating pattern 143 may include an electrically resistive heating element such as an electrically conductive track. The electrically resistive heating element may be supplied with power from a battery (not shown) and heated when currents flow in the electrically resistive heating element.

A heating temperature of the heating pattern 143 may be determined according to power consumption of an electrical resistance of the heating pattern 143. A resistance value of the heating pattern 143 may be set on the basis of power consumption of a resistance of the heating pattern 143 considering the heating temperature of the heating pattern 143. The resistance value of the heating pattern 143 may be variously set by a component material, a length, a width, a thickness, a pattern, or the like of an electrically resistive device.

The heating pattern 143 may include tungsten, gold, platinum, silver, copper, nickel, palladium, or a combination thereof. In addition, the heating pattern 143 may be doped with an appropriate doping material, and the material of the heating pattern 143 is not limited to the above-described example.

Both ends of the heating pattern 143 may be connected to the battery by a heating electrode 143e. The heating electrode 143e may correspond to electrical connection terminals that provide the heating pattern 143 with power supplied from the battery.

The sensing pattern 144 may be printed on the same surface of the first wick 142 as the heating pattern 143 to measure the temperature of the heating pattern 143.

Specifically, the sensing pattern 144 may include a resistor having a temperature co-efficient of resistance (TCR) for measuring the temperature of the heating pattern 143.

An electrical resistance of the resistor may be a temperature-dependent value, and thus it changes according to a change in temperature. The change in resistance may be derived by measuring a change in a voltage value as a current flows on the resistor of the sensing pattern 144. Accordingly, the change in resistance may be derived via a change in voltage, and the temperature of the heating pattern 143 may be measured based on the change in resistance.

However, the embodiments are not limited thereto, and the change in resistance may be derived by applying a constant voltage across the resistor of the sensing pattern 144 and measuring a change in the current value.

The sensing pattern 144 may include at least one material from among ceramic, semiconductor, metal, and carbon, and may include an electrically resistive device or an electrically conductive device like the heating pattern 143. For example, the sensing pattern 144 may include tungsten, gold, platinum, silver, copper, nickel, palladium, or a combination thereof, and may be doped with an appropriate doping material.

Both ends of the sensing pattern 144 may be connected to a controller (not shown) by a sensor electrode 144e. The sensor electrode 144e may correspond to electrical connection terminals for electrically connecting the sensing pattern 144 to the controller.

The both ends of the heating pattern 143 and the both ends of the sensing pattern 144 may be drawn to the outside of the first wick 142 from one of outer surfaces of the first wick 142, such that the heating pattern 143 and the sensing pattern 144 are easily connected to the battery and/or the controller.

The heating electrode 143e and the sensor electrode 144e may be arranged adjacent to one surface from among the outer surfaces of the first wick 142 described above, and may be connected to the both ends of the heating pattern 143 and the both ends of the sensing pattern 144, which are drawn to the outside of the first wick 142, to extend side by side toward the battery and/or the controller.

FIGS. 7 and 8 illustrate that the heating pattern 143 and the sensing pattern 144 are on an upper surface of the first wick 142, but the embodiments are not limited to locations of patterns.

The vaporizer 14 may include the second wick 145 in contact with one surface of the first wick 142 on which the heating pattern 143 is printed, to improve atomization performance by increasing a contact area between a heating element and a wick.

The second wick 145 may be arranged adjacent to the one surface of the first wick 142 to absorb an aerosol generating material.

In an embodiment, like the first wick 142, the second wick 145 may have a hexahedral shape. For example, the second wick 145 may have a rectangular pillar shape. However, the embodiments are not limited to the above-described example, and the wick may have an approximately cylindrical, elongated, rod, or needle shape.

A portion of the second wick 145 may absorb the aerosol generating material supplied from the storage unit. For example, the aerosol generating material absorbed into the portion of the second wick 145 may move to the other portion of the second wick 145 according to capillary action.

Unlike the first wick 142 on which the heating pattern 143 and the sensing pattern 144 are printed, a separate pattern may not be printed on the second wick 145. In this case, the second wick 145 may be arranged to contact the heating pattern 143 printed on the first wick 142. The aerosol generating material absorbed into the second wick 145 may be heated by the heating pattern 143 printed on the first wick 142.

When a separate pattern is not printed on the second wick 145, the second wick 145 may include cotton, silica, SPL, melamine foam, and/or porous ceramic.

Referring to FIG. 8, the aerosol generating material may be absorbed from the storage unit into both ends of the first wick 142 and both ends of the second wick 145.

The aerosol generating material absorbed into the both ends of the first wick 142 may move to one surface of the first wick 142 on which the heating pattern 143 is printed.

The aerosol generating material absorbed into the both ends of the second wick 145 may move to a surface in contact with the second wick 145 and the heating pattern 143.

The aerosol generating material, which is close to the heating pattern 143, may be heated by the heating pattern 143, and thus an aerosol may be generated from the aerosol generating material. Here, both surfaces including the aerosol generating material may be heated with the beating pattern 143 in between, and thus, a larger amount of aerosol may be generated than when only one surface including the aerosol generating material is heated.

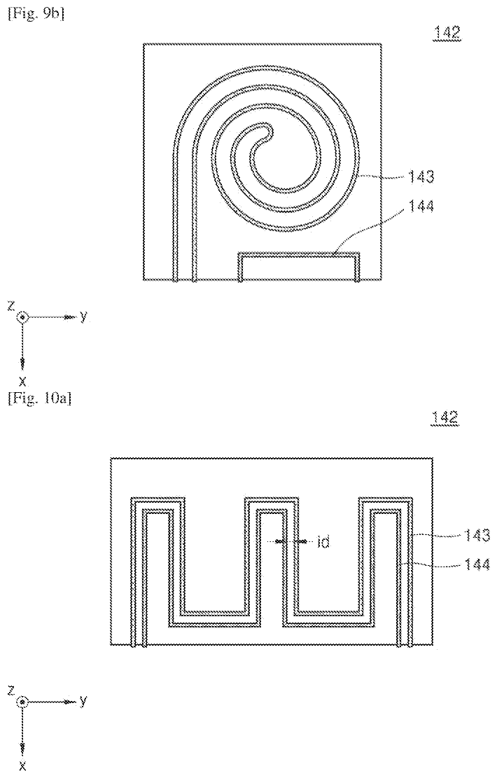

Hereinafter, patterns of the heating pattern 143 and the sensing pattern 144 printed on the first wick 142 are described below in detail with reference to FIGS. 9A to 12.

FIG. 9A is a top view illustrating a portion of a vaporizer according to another embodiment, and FIG. 9B is a top view illustrating a portion of a vaporizer according to yet another embodiment.

FIGS. 9A and 9B are views illustrating one surface of a first wick having a pattern printed thereon while omitting the second wick 145 in FIG. 8, which is viewed from a z-axis direction, and illustrating a heating pattern and a sensing pattern printed on the first wick.

Referring to FIGS. 9A and 9B, a heating pattern 143 may be printed on a first wick 142 in various shapes. For example, FIG. 9A illustrates that the heating pattern 143 having a bent shape is printed on one surface of the first wick 142. FIG. 9B illustrates that the heating pattern 143 having a spiral shape is printed on one surface of the first wick 142 having a rectangular pillar shape. However, the embodiments are not limited by a shape of a beating pattern.

A sensing pattern 144 may be printed on the one surface of the first wick 142 on which the heating pattern 143 is printed. In other words, the heating pattern 142 and the sensing pattern 144 may be printed on the same surface.

Like the heating pattern 143, the sensing pattern 144 may also be printed on the first wick 142 in various shapes. The embodiments are not limited by the shape of the sensing pattern illustrated in FIGS. 9A and 9B. However, the sensing pattern 144 and the heating pattern 143 may be formed not to intersect with each other to prevent abnormal operations thereof due to contact therebetween.

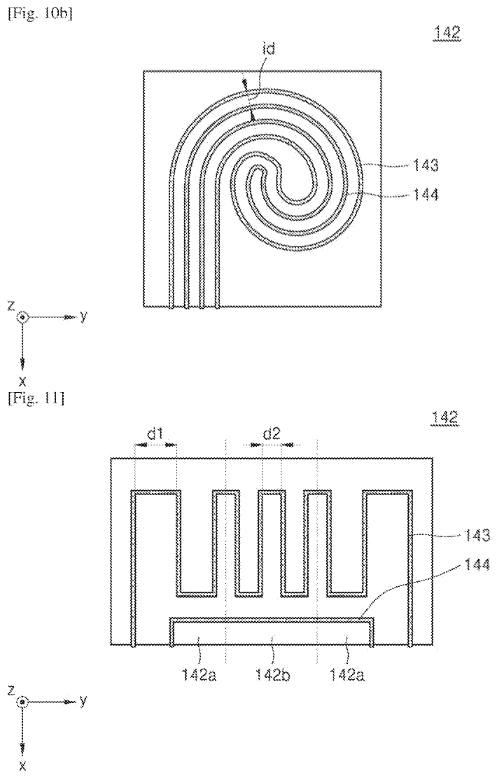

FIGS. 10A and FIG. 10B are top views illustrating a portion of a vaporizer according to some embodiments.

FIGS. 10A and 10B are views illustrating that a sensing pattern is arranged differently from FIGS. 9A and 9B.

Referring to FIGS. 10A and 10B, a sensing pattern 144 may be printed to be uniformly spaced apart from a heating pattern 143 to consistently and accurately measure a temperature of the heating pattern 133.

Here, for ease of a manufacturing process and reliable operation with an adjacent pattern, the sensing pattern 144 may be printed to maintain a distance id from the adjacent heating pattern 143 in a range of 0.1 mm to 0.5 mm, or at a constant value within the range. However, the distance id is only an example numerical value, and may be changed due to changes in parameters such as widths and thicknesses of the heating pattern 143 and the sensing pattern 144.

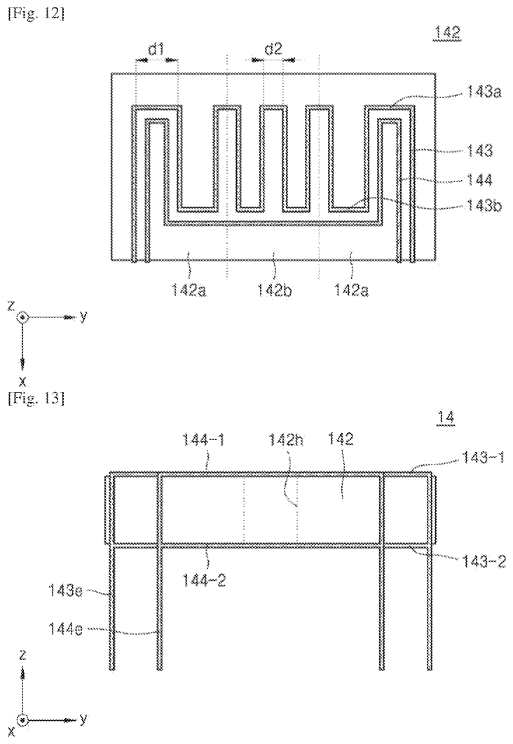

FIG. 11 is a top view of a portion of a vaporizer according to another embodiment.

FIG. 11 is a view illustrating that a heating pattern is arranged differently from FIG. 9A.

Referring to FIG. 11, a heating pattern 143 may be printed to have a first distance d1 between adjacent parallel portions on a peripheral portion 142a of a first wick 142 and may be printed to have a second distance d2 between adjacent parallel portions on a central portion 142b of the first wick 142. The second distance d2 is different from the first distance d1.

In an embodiment, the first wick 142 may absorb, through both ends of the peripheral portion 142a, an aerosol generating material supplied from a storage unit (not shown), and the absorbed aerosol generating material may move to the central portion 142b of the first wick 142. Here, a moving rate of the aerosol generating material may change as it goes from the peripheral portion 142a to the central portion 142b of the first wick 142.

An absorption rate of the aerosol generating material may be relatively high in the peripheral portion 142a of the first wick 142. This is because the peripheral portion 142a of the first wick 142 is connected to the storage unit and directly receives the aerosol generating material. After puffs, the aerosol generating material within the first wick 142 may be vaporized, and thus, the first wick 142 may be dry. When the first wick 142 is dry, the peripheral portion 142a of the first wick 142 may absorb the aerosol generating material at a high rate.

An absorption rate of the aerosol generating material in the central portion 142b of the first wick 142 may be lower than an absorption rate in the peripheral portion 142a of the first wick 142. The central portion 142b of the first wick 142 is located away from the storage unit, which results in a relatively long time for the aerosol generating material to arrive the central portion 142.

When analyzing micro sections constituting the first wick 142 in a longitudinal direction of the first wick 142, aerosols may be absorbed according to a difference in the degree of absorption of the aerosol generating material at both ends of each of the micro sections. Here, the longitudinal direction of the first wick 142 may refer to a y-axis direction in FIG. 11.

However, the difference in the degree of absorption of the aerosol generating material at both ends of each of the micro sections may decrease from the peripheral portion 142a toward the central portion 142b of the first wick 142. Therefore, the absorption rate of the aerosol generating material may decrease from the peripheral portion 142a toward the central portion 142b of the first wick 142.

When a heating pattern 143 is printed with a uniform interval (i.e., distance between adjacent parallel portions) in the longitudinal direction of the first wick 142, a smaller amount of aerosol may be generated in the central portion 142b than in the peripheral portion 142a. Accordingly, a non-uniform amount of aerosol may be generated along the longitudinal direction of the first wick 142.

In this regard, a shape of the heating pattern 143 needs to be differently printed on the first wick 142 along the longitudinal direction of the first wick 142.

For example, in the peripheral portion 142a of the first wick 142 in which the absorption rate of the aerosol generating material is high, a distance between adjacent parallel portions of the heating pattern 143 may be maintained at the first distance d1. In the central portion 142b of the first wick 142 in which the absorption rate of the aerosol generating material is relatively low, the distance between the patterns of the heating pattern 143 may be maintained at the second distance d2 that is less than the first distance d1. Accordingly, a uniform amount of aerosol may be generated along the longitudinal direction of the first wick 142.

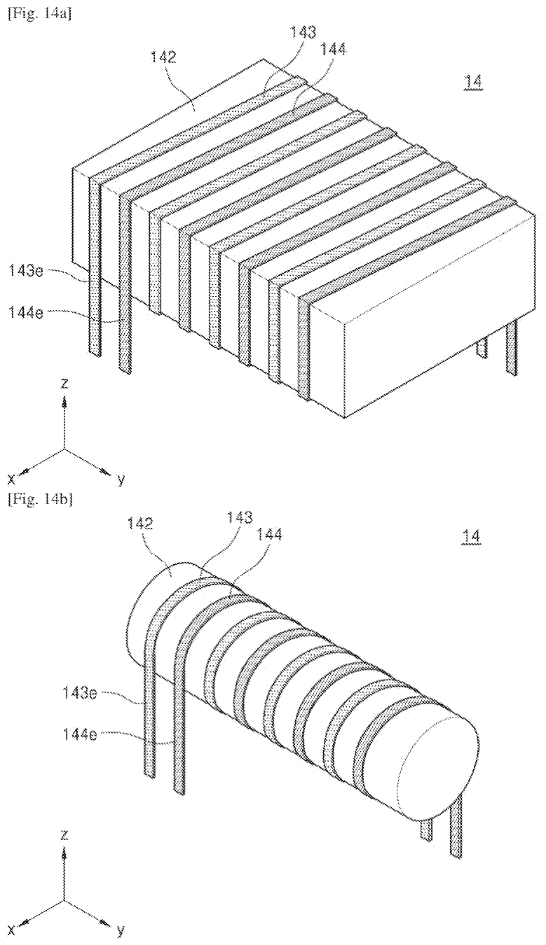

FIG. 12 is a top view of a portion of a vaporizer according to another embodiment.

FIG. 12 is a view illustrating that a sensing pattern is arranged differently from FIG. 11.

Referring to FIG. 12, a sensing pattern 144 may be printed in a different pattern shape according to a distance between patterns (i.e., adjacent parallel portions) of a heating pattern 143.

Referring to FIG. 12, a second distance d2 between patterns of the heating pattern 143 printed on a central portion 142b of a first wick 142 may be relatively smaller than a first distance d1 between patterns of the heating pattern 143 printed on a peripheral portion 142a of the first wick 142.

In the peripheral portion 142a of the first wick 142 on which the heating pattern 143 is printed with a relatively great distance, the sensing pattern 144 may be printed to be uniformly spaced apart from (i.e., parallel to) the heating pattern 143.

In the central portion 142b of the first wick 142 on which the heating pattern 143 is printed with a relatively small distance, the sensing pattern 144 may be printed to extend in a longitudinal direction of the first wick 142.

Specifically, the heating pattern 143 may include a plurality of bent portions 143a that are sequentially arranged in one direction (e.g., along the y-axis direction), and a plurality of connection portions 143b that connect the plurality of bent portions 143a in the one direction. In this case, at least a portion of the sensing pattern 144 may extend in the one direction in which the plurality of bent portions 143a of the heating pattern 143 are arranged.

A distance between patterns of the heating pattern 143, which is a reference of the shape of the sensing pattern 144, is not limited.

FIG. 13 is a front view illustrating a portion of a vaporizer according to another embodiment.

Referring to FIG. 13, a heating pattern 143 of a vaporizer 14 according to an embodiment may include a first heating pattern 143-1 and a second heating pattern 143-2.

The vaporizer 14 may include the first heating pattern 143-1 and the second heating pattern 143-2, which are respectively printed on opposite surfaces of a first wick 142, to improve atomization performance by increasing a contact area between a heating element and a wick.

An aerosol generating material absorbed into both ends of the first wick 142 may move to the surfaces on which the first heating pattern 143-1 and the second heating pattern 143-2 are respectively printed.

The aerosol generating material, which is close to the first heating pattern 143-1 and the second heating pattern 143-2, may be heated by the first heating pattern 143-1 and the second heating pattern 143-2, and an aerosol may be generated from the aerosol generating material. Here, the aerosol generating material may be heated on two opposite surfaces of the first wick 142, and thus, a larger amount of aerosol may be generated than when the aerosol generating material is heated only on the one surface.

In this case, a sensing pattern 144 may also include a first sensing pattern 144-1 and a second sensing pattern 144-2 which are printed on the surfaces of the first wick 142 where the first heating pattern 143-1 and the second heating pattern 143-2 are respectively printed.

The first sensing pattern 144-1 may measure a temperature of the first heating pattern 143-1, and the second sensing pattern 144-2 may measure a temperature of the second heating pattern 143-2.

Although the second wick 145 is not illustrated in FIG. 13, the second wick 145 may be arranged to contact the upper surface of the first wick 142 on which the first beating pattern 143-1 is printed and/or the lower surface of the first wick 142 on which the second heating pattern 143-2 is printed.

The first wick 142 may include a hollow 142h formed to allow the aerosol generated on the one surface or the lower surface to pass through the first wick 142.

The hollow 142h may penetrate the first wick 142 in a z-axis direction. However, the size, number, and location of the hollow 142h may be variously modified according to embodiments.

If an air flow passage (not shown) is arranged above the first wick 142 and the aerosol needs to move in a +z direction, the aerosol generated on the lower surface of the first wick 142 by the second heating pattern 143-2 may move in the +z direction through the hollow 142h.

In contrast, if the air flow passage is arranged under the first wick 142 and the aerosol needs to move in a −z direction, the aerosol generated on the upper surface of the first wick 142 by the first heating pattern 143-1 may move in the −z direction through the hollow 142h.

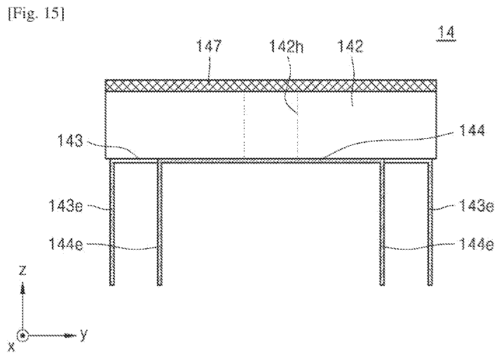

FIGS. 14A and 14B are each a perspective view illustrating a portion of a vaporizer according to an embodiment.

Referring to FIGS. 14A and 14B, a heating pattern 143 of a vaporizer 14 according to an embodiment may be printed to surround at least a portion of a first wick 142.

As illustrated in FIG. 14A, the heating pattern 143 may be printed to surround four sides of the first wick 142 having a rectangular pillar shape, to improve atomization performance by increasing a contact area between a heating element and a wick. As illustrated in FIG. 14B, the heating pattern 143 may be printed to surround an outer circumferential surface of the first wick 142 having a cylindrical shape.

However, the embodiments are not limited to the shape of the first wick 142 and the shape of the heating pattern 143 surrounding the first wick 142.

An aerosol generating material absorbed into both ends of the first wick 142 may be heated by the heating pattern 143 surrounding at least the portion of the first wick 142 and an aerosol may be generated from the aerosol generating material. Here, the aerosol generating material may be heated on many surfaces of the first wick 142 surrounded by the heating pattern 143, and thus, a larger amount of aerosol may be generated than when heated only on one surface.

FIG. 15 is a front view illustrating a portion of a vaporizer in which a mesh body is arranged, according to an embodiment.

Referring to FIG. 15, a vaporizer 14 according to an embodiment may include a mesh body 147.

The mesh body 147 may be arranged adjacent to the upper surface of a first wick 142 to absorb an aerosol generating material from a storage unit (not shown) and to beat the absorbed aerosol generating material. Here, the upper surface of the first wick 142 may refer to a surface of the first wick 142 other than the surface of the first wick 142 on which a heating pattern 143 is printed.

The mesh body 147 may include a plurality of conductive filaments heated by a current supply. In an example, the plurality of conductive filaments may be arranged in a net (or mesh) form, and when the plurality of conductive filaments are arranged in the above-described form, a plurality of gaps may be formed between the plurality of conductive filaments.

The plurality of conductive filaments of the mesh body 147 may allow a capillary action (or the capillary) to occur in the plurality of gaps, and the aerosol generating material stored in the storage unit may move into the plurality of gaps by the capillary action occurring in the plurality of gaps.

The aerosol generating material in the plurality of gaps may be in contact with the plurality of conductive filaments of the mesh body 147, and the plurality of conductive filaments may generate an aerosol by heating the aerosol generating material.

In other words, an aerosol may be generated through the mesh body 147 without a component (e.g., a wick) for transferring the aerosol generating material, which is stored in the storage unit, to the mesh body 147.

Referring to FIG. 15, the aerosol generating material may be absorbed from the storage unit to both ends of a first wick 142 and both ends of the mesh body 147.

The aerosol generating material absorbed into the both ends of the first wick 142 may move to one surface of the first wick 142 on which a heating pattern 143 is printed and another surface of the first wick 142 on which the mesh body 147 is arranged.

The aerosol generating material, which is close to the heating pattern 143 printed on the one surface of the first wick 142, may be heated by the heating pattern 143 and an aerosol may be generated from the aerosol generating material.

The aerosol generating material, which has moved close to the mesh body 147 arranged on the other surface of the first wick 142 after being absorbed into the first wick 142, may heated by the mesh body 147 and an aerosol may be generated from the aerosol generating material.

Apart from the aerosol generating material absorbed into the first wick 142, the aerosol generating material absorbed into the both ends of the mesh body 147 may be heated by the mesh body 147 to generate an aerosol from the aerosol generating material.

Due to the arrangement of the mesh body 147, the aerosol generating material may be heated on both surfaces of the first wick 142. In addition, the aerosol generating material may also be absorbed into and heated by the mesh body 147, and thus, a larger amount of aerosol may be generated than when the aerosol generating material is heated only on one surface of the first wick 142.

As illustrated in FIG. 15, the heating pattern 143 may be printed on the lower surface of the first wick 142, and the mesh body 147 may be arranged on the upper surface of the first wick 142, but the embodiments are not limited thereto.

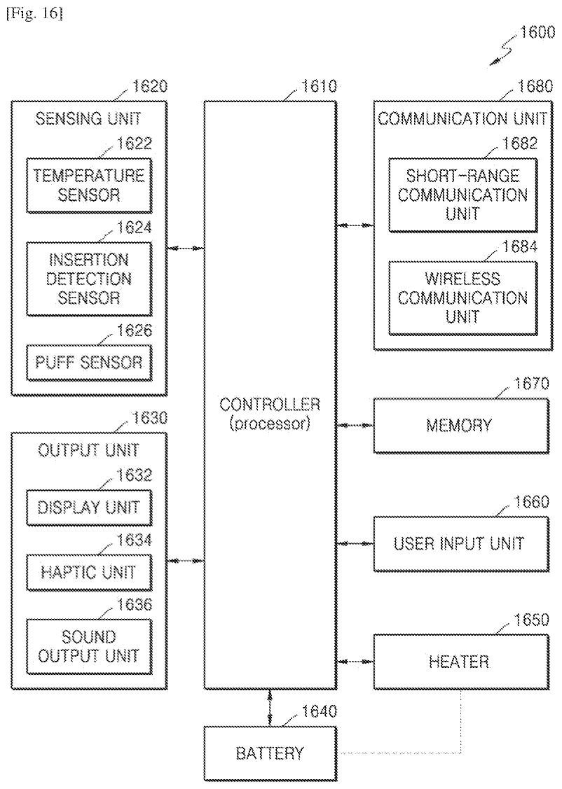

FIG. 16 is a block diagram of an aerosol generating device 1600 according to another embodiment.

The aerosol generating device 1600 may include a controller 1610, a sensing unit 1620, an output unit 1630, a battery 1640, a heater 1650, a user input unit 1660, a memory 1670, and a communication unit 1680. However, the internal structure of the aerosol generating device 1600 is not limited to those illustrated in FIG. 16. In other words, according to the design of the aerosol generating device 1600, it will be understood by one of ordinary skill in the art that some of the components shown in FIG. 16 may be omitted or new components may be added.

The sensing unit 1620 may sense a state of the aerosol generating device 1600 and a state around the aerosol generating device 1600, and transmit sensed information to the controller 1610. Based on the sensed information, the controller 1610 may control the aerosol generating device 1600 to perform various functions, such as controlling an operation of the heater 1650, limiting smoking, determining whether an aerosol generating article (e.g., a cigarette, a cartridge, or the like) is inserted, displaying a notification, or the like.

The sensing unit 1620 may include at least one of a temperature sensor 1622, an insertion detection sensor, and a puff sensor 1626, but is not limited thereto.

The temperature sensor 1622 may sense a temperature at which the heater 1650 (or an aerosol generating material) is heated. The aerosol generating device 1600 may include a separate temperature sensor for sensing the temperature of the heater 1650, or the heater 1650 may serve as a temperature sensor. Alternatively, the temperature sensor 1622 may also be arranged around the battery 1640 to monitor the temperature of the battery 1640.

The insertion detection sensor 1624 may sense insertion and/or removal of an aerosol generating article. For example, the insertion detection sensor 1624 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1626 may sense a user's puff on the basis of various physical changes in an airflow passage or an airflow channel. For example, the puff sensor 1626 may sense a user's puff on the basis of any one of a temperature change, a flow change, a voltage change, and a pressure change.

The sensing unit 1620 may include, in addition to the temperature sensor 1622, the insertion detection sensor 1624, and the puff sensor 1626 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1630 may output information on a state of the aerosol generating device 1600 and provide the information to a user. The output unit 1630 may include at least one of a display unit 1632, a haptic unit 1634, and a sound output unit 1636, but is not limited thereto. When the display unit 1632 and a touch pad form a layered structure to form a touch screen, the display unit 1632 may also be used as an input device in addition to an output device.

The display unit 1632 may visually provide information about the aerosol generating device 1600 to the user. For example, information about the aerosol generating device 1600 may mean various pieces of information, such as a charging/discharging state of the battery 1640 of the aerosol generating device 1600, a preheating state of the heater 1650, an insertion/removal state of an aerosol generating article, or a state in which the use of the aerosol generating device 1600 is restricted (e.g., sensing of an abnormal object), or the like, and the display unit 1632 may output the information to the outside. The display unit 1632 may be, for example, a liquid crystal display panel (LCD), an organic light-emitting diode (OLED) display panel, or the like. In addition, the display unit 1632 may be in the form of a light-emitting diode (LED) light-emitting device.

The haptic unit 1634 may tactilely provide information about the aerosol generating device 1600 to the user by converting an electrical signal into a mechanical stimulus or an electrical stimulus. For example, the haptic unit 1634 may include a motor, a piezo-electric element, or an electrical stimulation device.

The sound output unit 1636 may audibly provide information about the aerosol generating device 1600 to the user. For example, the sound output unit 1636 may convert an electrical signal into a sound signal and output the same to the outside.

The battery 1640 may supply power used to operate the aerosol generating device 1600. The battery 1640 may supply power such that the heater 1650 may be heated. In addition, the battery 1640 may supply power required for operations of other components (e.g., the sensing unit 1620, the output unit 1630, the user input unit 1660, the memory 1670, and the communication unit 1680) in the aerosol generating device 1600. The battery 1640 may be a rechargeable battery or a disposable battery. For example, the battery 1640 may be a lithium polymer (LiPoly) battery, but is not limited thereto.

The heater 1650 may receive power from the battery 1640 to heat an aerosol generating material. Although not illustrated in FIG. 16, the aerosol generating device 1600 may further include a power conversion circuit (e.g., a direct current (DC)/DC converter) that converts power of the battery 1640 and supplies the same to the heater 1650. In addition, when the aerosol generating device 1600 generates aerosols in an induction heating method, the aerosol generating device 1600 may further include a DC/alternating current (AC) that converts DC power of the battery 1640 into AC power.

The controller 1610, the sensing unit 1620, the output unit 1630, the user input unit 1660, the memory 1670, and the communication unit 1680 may each receive power from the battery 1640 to perform a function. Although not illustrated in FIG. 16, the aerosol generating device 1600 may further include a power conversion circuit that converts power of the battery 1640 to supply the power to respective components, for example, a low dropout (LDO) circuit, or a voltage regulator circuit.

In an embodiment, the heater 1650 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1650 may be implemented by a metal wire, a metal plate on which an electrically conductive track is arranged, a ceramic heating element, or the like, but is not limited thereto.

In another embodiment, the heater 1650 may be a heater of an induction heating type. For example, the heater 1650 may include a suspector that heats an aerosol generating material by generating heat through a magnetic field applied by a coil.

The user input unit 1660 may receive information input from the user or may output information to the user. For example, the user input unit 1660 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 16, the aerosol generating device 1600 may further include a connection interface, such as a universal serial bus (USB) interface, and may connect to other external devices through the connection interface, such as the USB interface, to transmit and receive information, or to charge the battery 1640.

The memory 1670 is a hardware component that stores various types of data processed in the aerosol generating device 1600, and may store data processed and data to be processed by the controller 1610. The memory 1670 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1670 may store an operation time of the aerosol generating device 1600, the maximum number of puffs, the current number of puffs, at least one temperature profile, data on a user's smoking pattern, etc.

The communication unit 1680 may include at least one component for communication with another electronic device. For example, the communication unit 1680 may include a short-range wireless communication unit 1682 and a wireless communication unit 1684.

The short-range wireless communication unit 1682 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+communication unit, or the like, but is not limited thereto.

The wireless communication unit 1684 may include a cellular network communication unit, an Internet communication unit, a computer network (e.g., local area network (LAN) or wide area network (WAN)) communication unit, or the like, but is not limited thereto. The wireless communication unit 1684 may also identify and authenticate the aerosol generating device 1600 within a communication network by using subscriber information (e.g., International Mobile Subscriber Identifier (IMSI)).

The controller 1610 may control general operations of the aerosol generating device 1600. In an embodiment, the controller 1610 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1610 may control the temperature of the heater 1650 by controlling supply of power of the battery 1640 to the heater 1650. For example, the controller 1610 may control power supply by controlling switching of a switching element between the battery 1640 and the heater 1650. In another example, a direct heating circuit may also control power supply to the heater 1650 according to a control command of the controller 1610.

The controller 1610 may analyze a result sensed by the sensing unit 1620 and control subsequent processes to be performed. For example, the controller 1610 may control power supplied to the heater 1650 to start or end an operation of the heater 1650 on the basis of a result sensed by the sensing unit 1620. As another example, the controller 1610 may control, based on a result sensed by the sensing unit 1620, an amount of power supplied to the heater 1650 and the time the power is supplied, such that the heater 1650 may be heated to a certain temperature or maintained at an appropriate temperature.

The controller 1610 may control the output unit 1630 on the basis of a result sensed by the sensing unit 1620. For example, when the number of puffs counted through the puff sensor 1626 reaches a preset number, the controller 1610 may notify the user that the aerosol generating device 1600 will soon be terminated through at least one of the display unit 1632, the haptic unit 1634, and the sound output unit 1636.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. A vaporizer comprising:
a storage unit configured to store an aerosol generating material:
a first wick configured to absorb the aerosol generating material from the storage unit;
a heating pattern printed on at least one surface of the first wick and configured to heat the aerosol generating material absorbed into the first wick; and
a sensing pattern printed on a same surface of the first wick as the heating pattern and configured to measure a temperature of the heating pattern.

2. The vaporizer of claim 1, wherein a portion of the first wick is in contact with the aerosol generating material stored in the storage unit.

3. The vaporizer of claim 1, wherein the first wick includes porous ceramic.

4. The vaporizer of claim 1, wherein the sensing pattern includes a resistor having a temperature coefficient of resistance (TCR) for measuring the temperature of the heating pattern.

5. The vaporizer of claim 1, wherein both ends of the heating pattern and both ends of the sensing pattern are drawn to outside of the first wick from the same surface of the first wick.

6. The vaporizer of claim 1, further comprising a second wick arranged adjacent to the same surface of the first wick and configured to absorb the aerosol generating material from the storage unit.

7. The vaporizer of claim 1, wherein the sensing pattern is spaced apart from the heating pattern and extends parallel to the heating pattern.

8. The vaporizer of claim 1, wherein the heating pattern includes first parallel portions spaced apart by a first distance on a peripheral portion of the first wick, and second parallel portions spaced apart by a second distance, which is different from the first distance, on a central portion of the first wick.

9. The vaporizer of claim 1, wherein
the heating pattern includes a plurality of bent portions arranged sequentially in one direction, and a plurality of connection portions connecting the plurality of bent portions in the one direction, and at least a portion of the sensing pattern extends in the one direction.

10. The vaporizer of claim 1, wherein the heating pattern includes a first heating pattern printed on one surface of the first wick and a second heating pattern printed on another surface of the first wick opposite to the one surface.

11. The vaporizer of claim 1, wherein the first wick includes a hollow for allowing an aerosol generated from the aerosol generating material to pass through the first wick.

12. The vaporizer of claim 1, wherein the heating pattern is printed to surround at least a portion of the first wick.

13. The vaporizer of claim 1, further comprising a mesh body arranged adjacent to one surface of the first wick where the heating pattern is not printed, and configured to absorb the aerosol generating material and heat the absorbed aerosol generating material.

14. An aerosol generating device comprising:
the vaporizer of claim 1;
a battery configured to supply power to the vaporizer; and
a controller configured to control the power supplied to the vaporizer.

15. The aerosol generating device of claim 14, further comprising:
a housing including an accommodation space in which an aerosol generating article is accommodated; and
a heater configured to heat the aerosol generating article accommodated in the housing,
wherein an aerosol generated in the vaporizer is delivered to the accommodation space.
